(19) United States
(12) Patent Application Publication
(10) Pub. No.: US 2023/0246868 A1
(43) Pub. Date: Aug. 3, 2023

(54) Monitoring Call Quality of a Video Conference to Indicate Whether Speech Was Intelligibly Received

(71) Applicant: Koa Health B.V., Barcelona (ES)

(72) Inventors: Albert Garcia i Tormo, Barcelona (ES); Miguel González, Barcelona (ES); Javier Acedo, Barcelona (ES); Johan Lantz, Barcelona (ES)

(21) Appl. No.: 17/680,168

(22) Filed: Feb. 24, 2022

(30) Foreign Application Priority Data
Jan. 31, 2022 (EP) 22154300.2

(51) Int. Cl. H04L 12/18; G10L 15/26; H04L 69/16; H04L 69/28

(52) U.S. Cl. CPC H04L 12/1831; G10L 15/26; H04L 69/16; H04L 69/28

(57) ABSTRACT

The intelligibility of a video conference is monitored using speech-to-text conversion and by comparing text as spoken to text converted from received audio. A first portion of audio data of speech of a user which is timestamped with a first time is input into a first audio and text analyzer. A second portion of the audio data, which is also timestamped with the first time, is received onto a remote audio and text analyzer. The first audio and text analyzer converts the first portion of audio data into a first text fragment. The remote audio and text analyzer converts the second portion of audio data into a second text fragment. The first audio and text analyzer receives the second text fragment. The first text fragment is compared to the second text fragment. Whether the first text fragment matches the second text fragment is indicated to the user on a display.

### CROSS REFERENCE TO RELATED APPLICATION

This application is based on and hereby claims the benefit under 35 U.S.C. § 119 from European Patent Application No. EP 22154300.2, filed on Jan. 31, 2022, in the European Patent Office. This application is a continuation-in-part of European Patent Application No. EP 22154300.2, the contents of which are incorporated herein by reference.

### TECHNICAL FIELD

The present invention relates to a system and method for monitoring communication quality, for example, in the context of videoconferences or telephone conferences.

### BACKGROUND

In recent years, remote communication technologies have increasingly gained popularity, a process especially fueled by the recent COVID-19 pandemic and the associated restrictions, such as a requirement to work remotely.

However, a wide use of such remote communication technologies such as videoconferences in the professional environment has so far been hampered by connectivity problems and losses of transmitted information leading to overall sub-optimal call quality, which leaves participants of video conferences unable to determine whether other participants can actually understand them to a satisfactory degree.

For instance, consider the sentence, “You should not do this.” If the word “not” is omitted during the transmission of this message to another participant, this still yields a grammatically correct sentence (“You should do this”) but with the opposite meaning. Such situations can indeed occur during videoconferences, and currently there are no means for a speaker to be aware of such a change in the transmitted message unless another participant explicitly asks.

The object of the present invention is to alleviate or even eliminate these problems. In particular, it is an object of the present invention to provide an improved system and method for monitoring the quality of communication, for example, in the context of video or telephone conferences.

### SUMMARY

A method for monitoring call quality in a video conference uses speech-to-text conversion to compare text fragments as spoken by a first user to corresponding text fragments converted from audio data as received by a remote second user. An audio signal containing encoded audio data of speech of the first user is received onto a first audio and text analyzer. A first portion of the encoded audio data is timestamped with a first time. The audio signal containing the encoded audio data is also received onto a remote audio and text analyzer as presented to the second user. The encoded audio data received onto the remote audio and text analyzer includes a second portion of the encoded audio data that is also timestamped with the first time. The first audio and text analyzer converts the first portion of the encoded audio data into a first fragment of text. The remote audio and text analyzer converts the second portion of the encoded audio data into a second fragment of text. The first audio and text analyzer receives the second fragment of text. The first fragment of text is compared to the second fragment of text. Whether the first fragment of text exactly matches the second fragment of text is indicated to the first user on a graphical user interface. For example, the indicating whether the first fragment of text exactly matches the second fragment of text includes indicating that a word of the first fragment of text is missing from the second fragment of text.

In one implementation, the first user is a mental health professional who is delivering a mental health treatment session to a patient, the second user. The method indicates whether the speech of the mental health professional is being intelligibly received by the patient.

In another embodiment, call quality of a video conference is monitored using speech-to-text conversion to compare text fragments as spoken by a remote second user to corresponding text fragments converted from audio data as received by a first user. An audio signal containing encoded audio data representing the speech of the remote second user is received from a remote audio and text analyzer. A first portion of the encoded audio data is timestamped with a first time and is converted into a first fragment of text. A second portion of the encoded audio data, which is also timestamped with the first time, is converted by the remote audio and text analyzer into a second fragment of text. The second fragment of text is received from the remote audio and text analyzer. The first fragment of text is compared to the second fragment of text. A system for monitoring call quality indicates on a graphical user interface whether the first fragment of text converted from audio data as received by the first user exactly matches the second fragment of text converted remotely from audio data as spoken by the second user. In one implementation, the first user is a physician who is providing a mental health therapy to a patient, the second user. The method indicates whether the physician is intelligibly receiving the speech of the patient.

In another embodiment, the video quality of video conference is monitored by comparing patterns that are recognized in the video signal as generated and as remotely received. A video signal containing digital image data is received onto a first image recognition system. A first portion of the digital image data is timestamped with a first time. The video signal containing the digital image data is received onto a remote image recognition system. The digital image data received onto the remote image recognition system includes a second portion of the digital image data that is also timestamped with the first time. The first image recognition system recognizes a first pattern in the first portion of the digital image data. The remote image recognition system recognizes a second pattern in the second portion of the digital image data. The first image recognition system receives the recognized second pattern. The recognized first pattern is compared to the recognized second pattern. A system for monitoring video quality of a video conference indicates on a graphical user interface whether the recognized first pattern matches the recognized second pattern. In one implementation, the first pattern is a number that is incremented with each successive digital image of the video signal. The indicating whether the recognized first pattern matches the recognized second pattern includes indicating whether the number formed by the first pattern equals a number that is recognized by the remote image recognition system to be formed by the second pattern.

In yet another embodiment, a novel method for monitoring the quality of communication between two devices involves converting the input received at the first device into first and second sequences of information, wherein the second sequence includes a first piece of information extracted from the input, sending the first sequence to the second device, which receives the first sequence as a third sequence, extracting a second piece of information from the third sequence to generate a fourth sequence, comparing the first piece of information from the second sequence to the second piece of information from the fourth sequence to detect any deviations between the two, and indicating to the user of the first device any deviations between the second and fourth sequences, which is an indication of how intelligible the first sequence of information was after being transmitted to the second device.

The method for monitoring communication quality between at least two devices comprising receiving input from a user of the first device, converting the input into a first sequence of information, transmitting the first sequence of information to the second device, generating a second sequence of information based on the input by extracting from the input at least one piece of information corresponding to a past time instant, generating a third sequence of information by means of the second device, wherein the third sequence of information corresponds to the output of the second device based on the first sequence of information, generating a fourth sequence of information based on the third sequence of information by extracting from the third sequence at least one piece of information corresponding to a past time instant, wherein the at least one piece of information is preferably time-stamped, comparing the second and fourth sequences of information to detect any aberrances there between, wherein each piece of information of the second sequence of information is compared to a corresponding piece of information of the fourth sequence of information, and indicating for each piece of information of the first sequence of information an indication of the level of human intelligibility of the output performed of the second device based on that piece of information.

Other embodiments and advantages are described in the detailed description below. This summary does not purport to define the invention. The invention is defined by the claims.

### BRIEF DESCRIPTION OF THE DRAWING

The accompanying drawings, where like numerals indicate like components, illustrate embodiments of the invention.

FIG. 1 shows a first embodiment of the present invention.

FIG. 2 shows a second embodiment of the invention.

FIG. 3 shows a third embodiment of the invention.

FIG. 4 shows an exemplary graphical user interface of a device according to the present invention.

FIG. 5 shows a fourth embodiment of the invention.

FIG. 6 shows a fifth embodiment of the invention.

FIG. 7 shows a sixth embodiment of the invention.

FIG. 8 shows a seventh embodiment of the invention.

### DETAILED DESCRIPTION

Reference will now be made in detail to some embodiments of the invention, examples of which are illustrated in the accompanying drawings.

A method is disclosed for monitoring the quality of communication between at least two devices, the method comprising:

receiving, by means of a first device, input from a user; converting the input received from the user into a first sequence of information; transmitting the first sequence of information to a second device; generating a second sequence of information based on the received input by extracting from the received input at least one piece of information corresponding to a past time instant, wherein the at least one piece of information is preferably time-stamped; storing the second sequence of information in the first device; generating a third sequence of information by means of the second device, wherein the third sequence of information corresponds to an output to be output by the second device on the basis of the first sequence of information;

generating a fourth sequence of information based on the third sequence of information by extracting from the third sequence of information at least one piece of information corresponding to a past time instant, wherein the at least one piece of information is preferably time-stamped; transmitting the fourth sequence of information to the first device; comparing the second and fourth sequences of information to detect any aberrances there between, wherein each piece of information of the second sequence of information is compared to a corresponding piece of information of the fourth sequence of information; and indicating, preferably displaying, by means of the first device for each piece of information of the first sequence of information an indication of the level of human intelligibility of an output performed by the second device based on this piece of information and/or preferably an indication of the output performed by the second device based on this piece of information.

The level of human intelligibility of an output performed by the second device may be indicated for example, by color-coded symbols, such as a bar moving with the progression of time that appears in red if human intelligibility at a given time instant is poor (e.g., due to a loss of words or audio signals being distorted, etc.) and in green if human intelligibility at a given time instant is good, e.g., no loss of information has been detected.

Preferably, a method according to the present invention focuses on the level of human intelligibility of transmitted information (“how well could a listening participant understand the content of the speech of a speaking participant during a videoconference”) in contrast to focusing on the transmission fidelity at the level of bytes, data packages, or individual frames of a video (“how accurately was the speech transmitted”). For example, the loss of a single frame of a video stream or the loss of some audio data during compression or decompression may not impact the human intelligibility of the audio signal or message conveyed, e.g., another listening participant may still understand the speech of a talking participant of a videoconference. Such a loss of a single frame of a video stream or the loss of some audio data during compression or decompression may even be below the threshold of human perception and thus may not even be noticed by a listening participant of the videoconference.

In one embodiment, the method further includes the step: evaluating whether any detected aberrance between the second and fourth sequences of information is above or below a threshold of human perception and/or is relevant to human understanding.

For example, it may be the case that only a single package of audio or video data was lost during transmission from the first device to the second device, but this data loss is negligible to a user of the second device because human beings do not understand audio or video output on a data-package or frame basis. For example, a user might not be able to notice that a single frame of a video was lost or that audio data relating to background noise was lost because the listening user still understands what the speaking user has said and also still understands the video transmitted. Thus, there may be data losses during transmission that one of the users of the devices or even both users cannot perceive and that are thus not relevant to human understanding of transmitted content. Preferably, the present invention is thus not focused on detecting any, including even minute, aberrances between a message or sequence of information sent from the first device to a message or sequence of information received by the second device, but is focused on detecting and preferably reporting aberrances that are relevant to human understanding of the message.

Current videoconferencing solutions do include flow control mechanisms, which allow them to cope with issues like variable communication delays or lost packets/packages of data. In these cases the goal is optimizing the call quality given the available communications channel. Nevertheless, all these flow control mechanisms do not go higher than the transport layer; this means that they focus on small pieces of information (packets or packages) but not on the whole human-understandable message. Based on this mechanism, it is feasible to analyze the link quality, for example by counting the amount of packets with errors, but it is not possible to analyze the human intelligibility of the received message. Furthermore, it is not possible identify whether packets are lost, as protocols such as User Datagram Protocol (UDP) do not provide mechanisms for that. In contrast to existing solutions, the present invention preferably introduces new quality-analysis mechanisms at a high level to explicitly provide information to the user about the human intelligibility of the received message.

Aberrances that are expected above a threshold of human perception and/or are relevant to human understanding are identified and reported. For example, the message sent from the first device to the second device might be “I eat bread with oil,” and the feedback message being sent back from the second device to the first device might be “I eat bread width oil.” Thus, there appears to be an aberrance in the speech signal recorded at the first device (“with”) from the speech signal reproduced at the second device (“width”) that is relevant for human understanding of the message (in contrast to, e.g., a packet of background noise being lost). In this case, the aberrance may be indicated or reported to the user, preferably the user of the first device. However, judging how severe the aberrance is and whether the aberrance requires action from one of the users, for example by repeating the sentence, is left to the user. In the example of the first user of the first device saying “I eat bread with oil” and the message being reproduced by the second device of the second user as “I eat bread width oil,” the user of the first device may judge that this aberrance was not so severe for the other user to understand the message, and thus no repetition of the sentence is required.

In other words, this may offer the advantage that if aberrances between speech signals captured by the first device and audio signals reproduced by the second device are detected, these are only indicated to the user if they are relevant to human understanding of the speech signals. For example, during a video conference, background noise accompanying captured speech signals may not be accurately transmitted. This omission, however, does not compromise the human understanding of another participant of the video conference of the speech signals, so this aberrance from absolute transmission fidelity may be regarded as irrelevant to assessing call quality. Similarly, there may be data losses during transmission that are not perceptible to a human participant in a video conference. Such aberrances from absolute transmission fidelity may also be regarded as irrelevant to assessing call quality.

At least one piece of information is extracted from the received input such that the at least one piece of information corresponds to an entity, such as a word, a number, a pause, a frame, an image, or a sound included in the input that is relevant for human intelligibility of the input.

For example, an entity such as a word or a pause that is relevant for human understanding of speech may be extracted from a continuous stream of audio data stemming from speech captured by the first device.

In one embodiment, the input received from the user is acoustic/audio input, preferably input relating to speech, and the input is converted into the first sequence of information by compressing and/or encoding. For example, the acoustic/audio input is first digitized by a microphone, and the digitized audio data is then compressed and/or encoded. Conversely, on the receiving side, the received compressed and/or encoded audio data is preferably digitized audio data that is converted into an analogue signal output by a speaker.

The second and fourth sequences of information are generated by a speech-to-text converter and include text. The second and fourth sequences of information may be regarded as summary messages of the human intelligible content of acoustic or audio signals captured by the first device and reproduced by the second device. The second and fourth sequences of information may each take the form of a file or a continuous stream and may be in text format. Similarly, the sixth and eighth sequences of information may each take the form of a file or a continuous stream and may be in text format.

In one embodiment, a separate communication channel and preferably a communication protocol configured to preserve information integrity to a high degree is used to transmit the fourth sequence of information between the first and second devices. In other words, the summary message of the human intelligible content of acoustic or audio signals captured by the first device may be transmitted in a separate channel from the channel used for transmitting the actual preferably encoded and compressed acoustic or audio signals from the first device to the second device. For example, the separate communication channel for transmitting the fourth and/or sixth sequences of information may use a transmission control protocol (TCP) communication protocol. The first and fifth sequences of information may be sent via a communication channel using a user datagram protocol (UDP) communication protocol.

According to an embodiment, the output performed or reproduced by the second device based on the third sequence of information is indicated to a user of the first device, preferably by displaying subtitles corresponding to acoustic signals, preferably relating to speech, output by the second device, on an output unit, preferably a screen, of the first device.

For example, the user of the first device may receive feedback in the form of subtitles of the content reproduced to the user of the second device (“what is received” or “what the user hears”) based on the speech signals captured by the first device (“what is sent” or “what the user actually said”). Additionally or alternatively, the user of the first device may also receive feedback in the form of subtitles of the content sent to the user of the second device based on the speech signals captured by the first device (“what the first device captures from the actual speech of the user”).

The indication of the level of human intelligibility of an output performed by the second device based on this piece of information of the first sequence of information can relate to a symbol, a font or a color code. For example, words that were omitted may be displayed in red, italics or strike-though or be indicated in brackets or with an asterisk. Words that were transmitted with a satisfactory degree of human intelligibility may be indicated in green or in a specific font, etc. Words that were added may be displayed, e.g., in blue, underlined or shown in square brackets, etc. Of course, not only the addition or omission of words can impact human intelligibility of the output, but also the speed at which, e.g., a word is reproduced or the delay with which the word is reproduced. Thus, the addition and omission or words, the scrambling of words, distortions in sounds, the reproduction speed of words etc. are all merely examples of factors that impact human intelligibility of the output performed by the second device. The present invention is thus in no way limited to these examples, but is applicable to any factor likely to impact human intelligibility of the output performed by the second device.

In an embodiment, the indication of the level of human intelligibility of an output performed by the second device based on this piece of information of the first sequence is directed to a different sensory modality of the user than the input received from the user. For example, if acoustic or audio data, such as speech signals, are captured from the user of the first device, the indication of the level of human intelligibility may be visual, e.g., by displaying subtitles.

In another embodiment, the second sequence of information may be generated directly out of the audio data acquired by the microphone without an intermediate step of processing the audio data, for example, by compressing and/or encoding. Of course, the second sequence of information may also be generated out of the audio data acquired by the microphone after the audio data has been processed, e.g., by encoding and compressing.

In another embodiment, the first device captures speech and provides digital audio. This digital audio is compressed and encoded and sent to the second device. The very same compressed and encoded digital audio signal is also uncompressed and decoded at the source side, thus generating a new digital audio signal. This new digital audio signal is then converted to text and stored (thus forming the second sequence of information) and compared later on, e.g., with the fourth sequence of information.

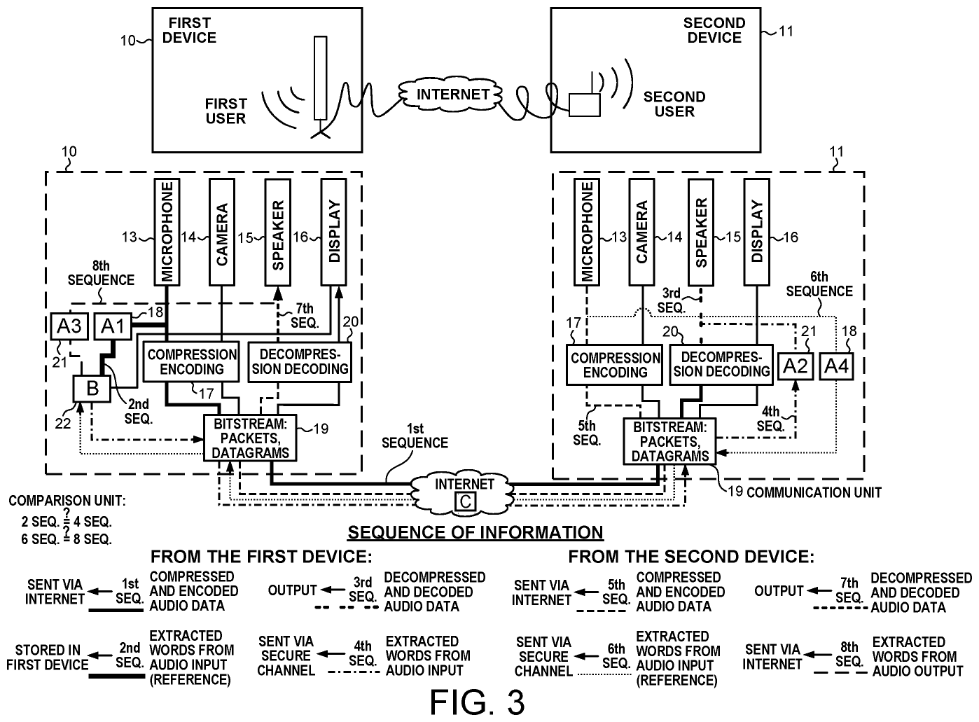

Although so far mainly the transmission of audio data has been discussed to illustrate the invention, the invention is not limited to audio data and is equally applicable to other data such as video data. It should be apparent for the person skilled in the art that if in an example, audio data has been described that is captured by a microphone and reproduced by a speaker, if the invention is to be applied to video data, the video data is captured by a camera and reproduced by a display. Thus, in the example in FIG. 3, the first and second devices both include a microphone, a camera, a speaker and a display and thus can be used for applying the invention to both audio and video data although the example of audio data is described in more detail.

An identifier is added to each piece of information of the first sequence of information (that in this example corresponds to a stream of frames of a video acquired by a camera, e.g., of the first device). For example, consecutive numbers may be added to consecutive frames of the video. A second sequence of information is generated from the first sequence of information, wherein each of the pieces of information of the second sequence of information is linked to an identifier. For example, a pattern A extracted from the first frame is linked to the number 1 and a pattern B extracted from the second frame is linked to the number 2 of the second frame. At the level of the second device, a video is displayed based on the first sequence of information. From the displayed video, a fourth sequence of information is generated, wherein each of the pieces of information of the fourth sequence of information is also linked to an identifier. For example, a pattern A extracted from the first frame is linked to the number 1, and a pattern C extracted from second frame is linked to the number 2. If the sequences are compared on a frame-by-frame basis, it is apparent in this example that the first frame was transmitted correctly, because the first frame captured by the first device contained pattern A, and the first frame displayed by the second device also contained pattern A. Pattern A can be, e.g., a face. The second frame captured by the first device contained pattern B (e.g., a close-up of the face) and the second frame displayed by the second device contained pattern C (e.g., a hand). Thus, there is an aberrance between the video recorded at the first device and the video displayed/reproduced by the second device. In other words, at the first device a pattern detector is run on each frame, and a list of extracted patterns is obtained. The same operation is performed by the second device for each of the received frames, and then the patterns extracted in both sides must coincide if the transmission was without any data loss.

In another embodiment, an identifier is added to each piece of information of the second sequence of information (e.g., a number is added to each frame extracted from a video stream). Thus, the second sequence of information may be regarded as a reference message of the video captured at the first device and may for example contain the sequence: frame 1, frame 2, frame 3, frame 4 indicating that four frames with identifiers in the form of consecutive numbers were contained in the video message sent from the first device to the second device. At the second device, the corresponding identifier is extracted from each piece of information of the fourth sequence of information. Thus, the fourth sequence of information may be regarded as a summary message of the video received by the second device and may contain the sequence: frame 1, frame 2, frame 4 indicating that only three frames (frames 1, 2 and 4) were contained in the video message reproduced by the second device. In other words, the identifiers of the pieces of the second and fourth sequences of information are compared to detect any aberrances of the first and second sequences of information corresponding in this example to the content contained in the video captured at the first device and the video reproduced at the second device. In other words, the camera of the first device may be regarded as providing the first sequence of information (in this case, a sequence of frames). An identifier is added to each of the frames (e.g., a frame number), and the sequence of frames with each frame bearing an identifier is sent to the second device. Thus, in this example, the sequence of frames with the identifiers can be regarded as the second sequence,

In another embodiment, the first device may send a stream of video frames to the second device wherein each frame contains an identifier, and the identifier is a stream of consecutive numbers. The second device may be configured to perform a plausibility check on the incoming video stream, for example, by evaluating whether the number of the identifier of each consecutive frame increases by 1. If the plausibility check indicates an error in the transmission, for example, if a frame with the identifier 4 follows on the frame with the identifier 2, this aberrance is indicated to the user of the first and/or second device.

If, via a conference, video is also transmitted, it is possible that packets of video data or even whole frames may be lost. This can cause interruptions in the video stream and mismatches or synchronization issues between the audio and video channels. Adding an identifier to each piece of information, e.g., each frame of a video, allows such losses to be detected.

In one embodiment, a specific pattern may be added as an identifier to each of the frames or images. For example, a small number at a corner of the image, or at the area overlapped by the self-video, or the frame may be extended and the identifier may be added outside the part of the frame that is shown to the user. This identifier can change from frame to frame or image to image, for example, like a loop counter of three digits. At the receiver side, the reconstructed image can be analyzed and the value of this number can be extracted, verifying that the counter is following the expected pattern (for instance, increment by 1 at each frame or image) to verify that no frames were lost. The information regarding lost frames or received frames on the side of the second device can be sent, preferably time-stamped, to the first device and any aberrances or losses of frames relevant to human understanding or above a threshold of human perception may be indicated. For example, to display a set of multiple consecutive lost frames, a marker such as an asterisk can be added next to the subtitles indicating concurrent audio signals to denote the video disruption. For easy evaluation, the marker may be color-coded according to the number of frames lost (severity of the disruption).

Another aspect of the present invention relates to a device, preferably configured to perform the novel method, wherein the device comprises:

at least one input unit, such as a microphone;

at least one output unit, such as a speaker;

at least one conversion unit configured to convert input received from a user via the input unit into a first sequence of information;

at least one extraction unit configured to generate a second sequence of information from the received input by extracting from the received input at least one piece of information corresponding to a past time instant, wherein the at least one piece of information is preferably time-stamped;

a memory for storing the second sequence of information;

at least one communication unit configured to transmit the first sequence of information to a second device and receive from the second device a fourth sequence of information, wherein the fourth sequence of information corresponds to at least one piece of information corresponding to a past time instant, wherein the at least one piece of information is preferably time-stamped and extracted from a third sequence of information corresponding to an output to be output by the second device on the basis of the first sequence of information;

at least one comparison unit configured to compare the second and fourth sequences of information to detect any aberrances there between, wherein each piece of information of the second sequence of information is compared to a corresponding piece of information of the fourth sequence of information; and

at least one evaluation unit configured to indicate for each piece of information of the first sequence of information an indication of the level of human intelligibility of an output performed by the second device based on this piece of information and preferably to indicate the output performed by the second device based on this piece of information.

In one embodiment, the evaluation unit is further configured to evaluate whether any detected aberrance between the second and fourth sequences of information is above or below a threshold of human perception.

Preferably, the communication unit comprises a separate communication channel that preferably uses a communication protocol that preserves information integrity to transmit the fourth sequence of information.

According to an embodiment, the device comprises a screen, a communication detection unit configured to detect whether the device is communicating with at least one other device, preferably in an audio and/or video call, and a control unit configured to control, if the communication detection unit has detected that the device is communicating with at least one other device, the device to display on the screen an indication of acoustic signals, preferably vocal signal, captured by the device via the input unit, wherein the indication preferably comprises subtitles and/or an indication of acoustic signals output by the at least one other device, wherein the indication preferably comprises subtitles and/or at least one statistical indicator of communication quality, such as an indication of a background noise, a signal-to-noise ratio, a connectivity strength, a transmission delay or a synchronization delay.

Another aspect of the invention relates to a system comprising at least two devices configured to perform the novel, preferably at least one device according to the present invention. The system includes a first device and a second device, which includes at least one input unit, such as a microphone; at least one output unit, such as a speaker; at least one conversion unit configured to convert input received from a user via the input unit into a fifth sequence of information; at least one extraction unit configured to generate a sixth sequence of information from the received input by extracting from the received input at least one piece of information corresponding to a past time instant, wherein the at least one piece of information is preferably time-stamped; and at least one communication unit configured to transmit the fifth and sixth sequences of information to the first device, wherein the first device comprises a conversion unit configured to generate a seventh sequence of information based on the fifth sequence of information received from the second device, wherein the seventh sequence of information corresponds to an output to be output by the first device on the basis of the fifth sequence of information, and the first device further comprises an extraction unit configured to generate an eighth sequence of information from the seventh sequence of information by extracting from the seventh sequence of information at least one piece of information corresponding to a past time instant, wherein the at least one piece of information is preferably time-stamped, and the at least one comparison unit of the first device is configured to compare the sixth and eighth sequences of information to detect any aberrances there between, wherein each piece of information of the sixth sequence of information is compared to a corresponding piece of information of the eighth sequence of information.

In the system, the first and/or the second device include a comparison unit and/or an evaluation unit.

Preferably, the at least one communication unit of the first device and the at least one communication unit of the second device are configured to provide a separate communication channel that preferably uses a communication protocol that preserves information integrity and transmits the fourth sequence of information and/or the sixth sequence of information between the first and second devices. For example, such a communication channel may use the TCP communication protocol. Other data may be transmitted in another channel using the UDP communications protocol.

Another aspect of the invention relates to a memory device containing machine-readable instructions that when read by a device enable the device to perform a novel method for monitoring communication quality. The method involves receiving raw audio data onto a first audio and text analyzer 27, wherein the raw audio data includes a first timestamp indicating a first time and receiving decoded audio data onto a remote audio and text analyzer 29, wherein the decoded audio data was generated by decoding encoded audio data, wherein the encoded audio data was generated by encoding the raw audio data, and wherein the decoded audio data includes the first timestamp indicating the first time. The raw audio data is converted into a first fragment of text by the first audio and text analyzer 27. The decoded audio data is converted into a second fragment of text by the remote audio and text analyzer 29. The second fragment of text is received by the first audio and text analyzer 27. The first fragment of text is compared to the second fragment of text. An indication is displayed on a graphical user interface as to whether the first fragment of text exactly matches the second fragment of text.

Another method for monitoring communication quality involves receiving decoded audio data onto a first audio and text analyzer 27, wherein the decoded audio data was generated by decoding encoded audio data, wherein the encoded audio data was generated by encoding raw audio data, and wherein the decoded audio data includes a first timestamp indicating a first time. The decoded audio data is converted into a first fragment of text. A second fragment of text is received from a remote audio and text analyzer 29, wherein the raw audio data was converted by the remote audio and text analyzer 29 into the second fragment of text, and wherein the second fragment of text also includes the first timestamp indicating the first time. The first fragment of text is compared to the second fragment of text. It is indicated on a graphical user interface whether the first fragment of text exactly matches the second fragment of text.

Yet another method for monitoring communication quality involves receiving video data onto a first image recognition system, wherein the video data includes a first timestamp indicating a first time, wherein the decoded video data is received onto a remote image recognition system. The decoded video data was generated by decoding encoded video data, and the encoded video data was generated by encoding the video data. The decoded video data received onto the remote image recognition system also includes the first timestamp indicating the first time. The method involves recognizing, by the first image recognition system, a first pattern in the video data and recognizing, by the remote image recognition system, a second pattern in the decoded video data. The recognized second pattern is received by the first image recognition system. The recognized first pattern is compared to the recognized second pattern. It is indicated on a graphical user interface whether the recognized first pattern exactly matches the recognized second pattern.

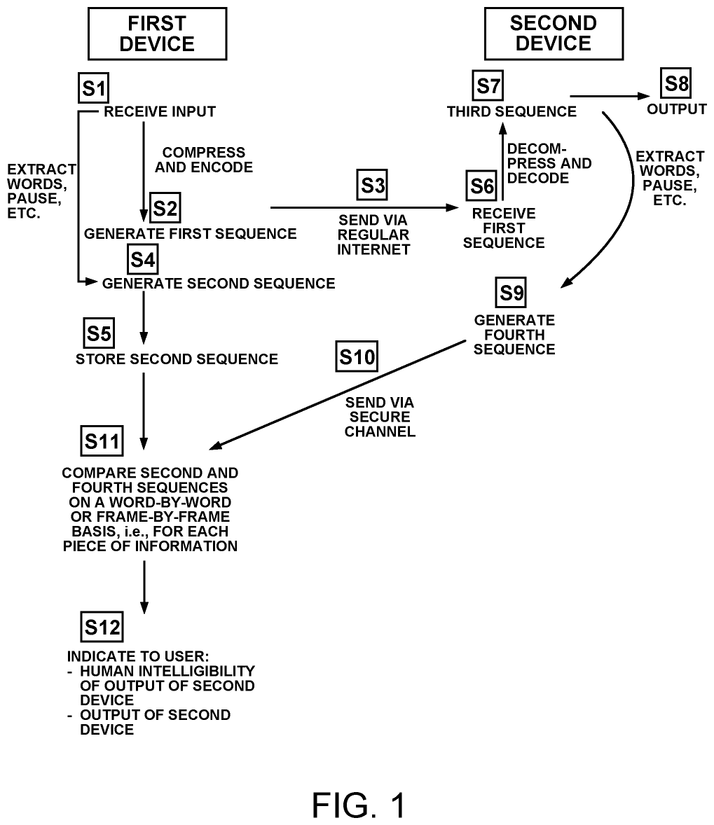

FIG. 1 illustrates the steps of a method in which a video conference user speaks into a first device, and a corresponding audio signal is received by a second device and reproduced to another user listening to the second device. The following description focuses on audio signals for ease of description, but the present invention is similarly applicable to video signals.

In step S1, by means of a first device such as a smartphone or tablet, an audio signal is received from a user. In step S2, the audio signal is compressed and encoded to generate the first sequence of information. The compressed and encoded audio signal is then sent in step S3 to a second device, such as a smartphone or tablet, via the internet.

Based on the audio signal received from the user, the first device also generates in step S4 a second sequence of information by extracting from the received input at least one piece of information, for example a word or a pause contained in the audio signal or speech signal received from the user. This at least one piece of information is associated with a past time instant. For example, the second sequence of information can contain the information that, 5 ms ago, the user uttered the word “You”. In this case, the past time instant is “−5 ms”. The at least one piece of information is time-stamped. For example, the word “You” may be linked to an absolute time value, such as the Universal Coordinated Time (UTC), to indicate when the user uttered this word. Alternatively, the word “You” may be linked to a relative time value, for example “30 sec after starting the videoconference”.

The second sequence of information may be regarded as the extracted content of the audio signal received from the user of the first device. In other words, the second sequence of information may be regarded as a reference message indicating the content, preferably the content as is intelligible to a human being, of the audio signal received from the user of the first device. For example, the second sequence of information can be generated through speech-to-text conversion in order to capture the meaning of the speech of the user of the first device. In step S5, the second sequence of information is stored in the first device. The second sequence of information may thus be regarded as a sender-side reference message.

In step S6, at the second device corresponding to the receiver-side, such as a smartphone or tablet, the first sequence of information is received. In step S7, a third sequence of information is generated at the second device, for example by decompressing and decoding the audio signal of the first sequence of information. In step S8, the decompressed and decoded audio signal of the third sequence of information corresponds to an output that is output by the second device on the basis of the first sequence of information. In other words, the third sequence of information may be regarded as reflecting the actual output, e.g., speech output via speakers of the second device, to the user of the second device. Whereas the first sequence of information may be regarded as what is actually said by the user of the first device, the third sequence of information may be regarded as what is actually reproduced by the second device.

In step S9, based on the third sequence of information, the second device generates a fourth sequence of information by extracting from the third sequence of information to be output to the user at least one piece of information, such as a word or a pause contained in the audio signal or speech signal. This at least one piece of information preferably corresponds to a past time instant, wherein the at least one piece of information is preferably time-stamped. The fourth sequence of information is generated in the same way as the second sequence of information. The fourth sequence of information is generated through speech-to-text conversion to capture the meaning of the speech reproduced by the second device to the user of the second device. The fourth sequence of information may thus be regarded as a receiver-side reference message. The fourth sequence of information is the extracted content of the audio signal that is reproduced and presented to the user of second first device. In other words, the fourth sequence of information is a reference message indicating the content, preferably the content as is intelligible to a human being, of the audio signal received by the user of the second device.

The second and fourth sequences use the same reference framework for linking the at least one piece of information to a past time instant and/or for time stamping, so that the second and fourth sequences of information can be compared on a piece of information-by-piece of information basis for each past time instant.

The pieces of information of the second and fourth sequences of information are co-registered in time in order to allow, for each point in time, a comparison of the pieces of information of the second and fourth sequences for this point in time. The same point of time is used as a reference for linking the at least one piece of information of the second and fourth sequences to a past time instant and/or for time stamping. If absolute timestamps are used, both the second and fourth sequences may rely on UTC. As using the same reference framework can be important for any comparison, the same applies to the sixth and eighth sequences. The term “co-registered” means that the second and fourth sequences are referenced to the same reference.

In step S10, the fourth sequence of information is then transmitted from the second device to the first device.

The fourth sequence of information is transmitted from the second device to the first device via the internet in a separate channel that is separate from the channel used to transmit the first sequence of information. There is a separation of the communication channels between the first and second devices for transmitting audio signals, such as the compressed and encoded audio data of the first sequence of information, and for transmitting extracted content of the audio signals, such as the fourth sequence of information. The channel of communication for transmitting the fourth sequence of information is configured to offer a higher level of cyber security and/or transmission fidelity than the channel of communication for transmitting the first sequence of information.

Generally, the amount of data transmitted in the channel of communication for transmitting the extracted content is significantly lower than the amount of data transmitted in the channel of communication for transmitting the actual compressed and encoded audio signal. Thus, transmitting the extracted content, e.g., the fourth sequence of information, in addition to the actual audio signal, e.g., the first sequence of information, will require only a negligible increase in processing power.

For example, the first sequence of information may include pieces of information relating to speech signals such as words, but may also include background noise as well information regarding volume, pitch and speed of the audio signal. The fourth sequence of information may be a file in text format generated through speech-to-text conversion and comprising only the human intelligible content “You should not do it.”

In step S11, after the fourth sequence of information has been transmitted to the first device, the first device compares the second and fourth sequences of information to detect any aberrances there between. The comparison is preferably performed on a piece of information-by-piece of information basis for each past time instant. Each piece of information of the second sequence of information is compared to a corresponding piece of information of the fourth sequence of information. Preferably, time-stamped pieces of information of the second and fourth sequences of information are co-registered in relation to time.

For example, the piece of information of the second sequence of information corresponding to the past time instant of −5 ms is the word “You” because the user uttered the word “You” at that time point. The piece of information of the fourth sequence of information corresponding to the past time instant of −5 ms is the word “You” because the audio output to be reproduced to the user of the second device for that time point is the word “You”. In this case, for the past time instant and/or piece of information there are no aberrances between the audio signal captured by the first device from the user (sender) and the audio signal reproduced from second device to the other user (receiver).

The past time instances and/or the pieces of information included in the sequences of information relate to entities relevant to the human understanding of the information contained in data from which the sequence of information was generated. For example, a piece of information may relate to a word or a pause identified in a continuous stream of audio data captured from a speaking user. Similarly, the continuous stream of audio data captured from a speaking user may be separated into discrete time instants corresponding to a word or a pause or another entity relevant to human understanding of the audio data. Thus, the term “past time instant” may also be understood as “past time interval.”

For example, from the continuous stream of audio data captured from a user saying “You should not do this”, the pieces of information “You”, “pause”, “should”, “pause”, “not”, “pause”, “do”, “pause”, “this”, “long pause” may be extracted. Each piece of information relates to an entity contained in the audio data that is relevant to and captures a human understanding of the audio data.

Each piece of information may be time-stamped so that each piece of information is allocated to a past time instant. For example, the word “You” is allocated to −5 ms, the entity “pause” is allocated to −3 ms, and the word “should” is allocated to −2 ms. Thus, when comparing two sequences of information of this format, it is possible to compare the sequences of information on an information-by-piece of information basis and/or a past time instant-by-past time instant basis.

In principle, it is also possible to compare the second and fourth sequences of information without the use of timestamps. For example, the second and fourth sequences of information may be aligned to detect any aberrances there between. A correlation algorithm may be used to align the pieces of information of the second and fourth sequences to detect aberrances there between. As the comparison between the sixth and eighth sequences is similar to or the same as the comparison between the second and fourth sequences of information, any explanation made in this disclosure relating to the comparison of the second and fourth sequences of information may equally be applied to the comparison of the sixth and eighth sequences of information.

In step S12, the first device then indicates to the user (sender) for each piece of information of the first sequence of information an indication of the level of human intelligibility of an output performed by the second device based on this piece of information. This indication can take the form of subtitles of the audio output being generated by the second device to the user (receiver) based on the audio input captured by the first device. The first device may be used to provide feedback to the user (sender) regarding what was received by the user (receiver) of the second device.

For example, the user of the first device said, “You should not do this,” but during the videoconference the word “not” was lost. So the user of the second device actually received the message, “You should do this.” The user of the first device may in this case receive the indication that the word “not” was lost during the transmission. On the first device the subtitle “You should not do this” is displayed to indicate to the user of the first device that the word “not” has been lost. Alternatively or additionally, an indication of the output performed by the second device based on this piece of information may be provided to the user of the first device, in this example a subtitle reading “You should do this”.

Subtitles are only one option for providing an indication for each piece of information of the first sequence of information of the level of human intelligibility of an output performed by the second device based on this piece of information, and any other suitable indication is also within the scope of the present invention.

The severity of any aberrances and/or the level of human intelligibility of each piece of information may also be indicated to the user, e.g., by using a color code that displays words transmitted with satisfactory transmission fidelity in green and indicates a word transmitted in a form that is not intelligible to a human being or that has been omitted completely in red or strike-through.

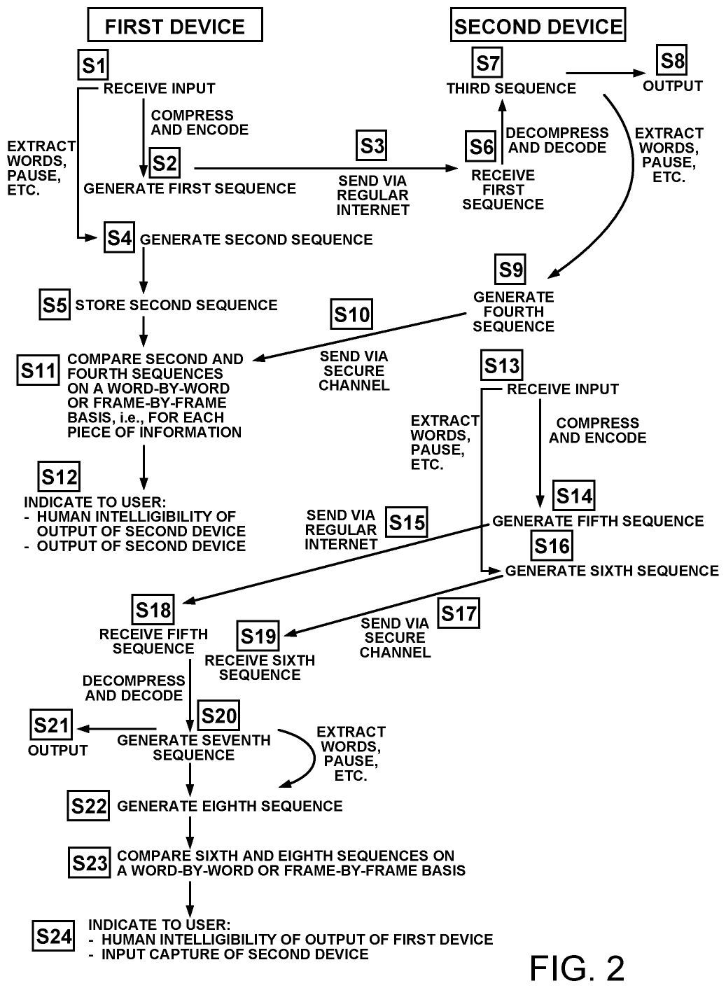

FIG. 2 shows another embodiment of the present invention. Steps S1-S12 of FIG. 2 correspond to steps S1-S12 of FIG. 1, and thus a redundant description of these steps is omitted.

In step S13, input from a user, e.g., an audio signal such as a speech signal, is received by the second device. This audio signal is then compressed and encoded to generate a fifth sequence of information in step S14. The compressed and encoded audio signal is then sent in step S15 to the first device, such as a smartphone or tablet, via the internet.

Based on the audio signal received from the user, in step S16 the second device also generates a sixth sequence of information by extracting from the received input at least one piece of information, such as a word or a pause contained in the audio signal or speech signal received from the user. This is the same or similar to the generating of the second sequence in step S4 by the first device.

In step S17, the sixth sequence of information is then transmitted via a separate secure communication channel to the first device.

In step S18 at the first device (corresponding to the receiver-side in this example), e.g., a smart-phone or tablet, the fifth sequence of information is received. In step S19, the sixth sequence of information is received.

In step S20, a seventh sequence of information is generated by means of the first device, for example, by decompressing and decoding the audio signal of the fifth sequence of information. In step S21, the decompressed and decoded audio signal of the third sequence of information corresponds to an output that is output by the second device on the basis of the first sequence of information.

In step S22, based on the seventh sequence of information, the first device generates an eighth sequence of information by extracting from the seventh sequence of information at least one piece of information, such as a word or a pause contained in the audio signal or speech signal to be output to the user.

Then in step S23, the first device compares the sixth and eighth sequences of information to detect any aberrances there between. The comparison is preferably performed on a piece of information-by-piece of information basis for each past time instant. The comparison is performed in the same or a similar way to the comparison described in step S11.

In this example, the first device in step S24 then indicates to the user (in this instance acting as the receiver) for each piece of information of the first sequence of information an indication of the level of human intelligibility of an output performed by the first device based on this piece of information, as well as an indication of the content of the audio signal captured by the second device, e.g., what the user of the second device said. The indication is performed in the same or a similar way to the indication described in step S12.

FIG. 3 shows a system for monitoring call quality that includes a first device 10 and a second device 11 that are used by a first and second user, respectively, to carry out a videoconference and preferably to perform the methods of FIGS. 1-2.

The first device 10 includes a microphone 13 and a camera 14 for receiving input from the first user and a speaker 15 and a display 16 for outputting or reproducing output to the first user. The first device 10 includes a conversion unit 17 configured to compress and encode audio signals, e.g., the input received from the first user. The first device 10 also includes an extraction unit 18 configured to extract entities relevant to human understanding from the received audio input, e.g., speech of the first user. The extraction unit 18 in this example is a speech-to-text converter that generates a text file from the captured speech. The first device 10 further includes a memory in which the text file is stored.

The first device 10 also includes a communication unit 19 configured to transmit data to the second device 11 and receive data from the second device 11. The communication unit 19 is configured to communicate with the second device 11 via two separate channels that exist simultaneously. In this example, one channel is used for sending the compressed and encoded audio signal received from the first user from the microphone 13, and the second channel is used to send the text file generated by the extraction unit 18.

The second device 11 receives the compressed and encoded audio signal via the communication unit 19 and decompresses and decodes the audio signal via a conversion unit 20 configured to decompress and decode audio signals. Based on the decompressed and decoded audio signal, the second device 11 outputs an audio signal via the speaker 15.

From decompressed and decoded audio signals representing the audio signal sent to the speaker 15 of the second device 11, entities relevant to human understanding from the audio output are extracted using an extraction unit 21. The extraction unit 21 in this example is a speech-to-text converter that generates a text file from the audio signal indicating the acoustic output to be reproduced to the user. The text file generated by the extraction unit 21 of the second device 11 is sent via the communication unit 19 of the second device 11 to the communication unit 19 of the first device 10.

The first device 10 also includes a comparison unit (B) 22 configured to compare the text file generated by the extraction unit (A1) 18 of the first device 10 with the corresponding text file generated by the extraction unit (A4) 18 of the second device 11 received from the second device 11.

Referring to the methods of FIGS. 1-2, the comparison unit 22 of the first device 10 in FIG. 3 compares the second sequence of information to the fourth sequence of information and/or compares the sixth sequence of information to the eight sequence of information. In order to avoid redundant description, FIG. 3 indicates which line in the diagram corresponds to which sequence of information. In addition, the first device 10 includes an evaluation unit configured to evaluate the level of human intelligibility of the output generated by the second device 11 based on encoded and compressed audio data sent to the second device 11 by the first device 10 and to indicate the output generated by the second device 11 on the display 16 of the first device 10.

The system of two devices as shown in FIG. 3 is only one embodiment. A system according to the present invention may also include at least two devices each configured like the first device 10 in FIG. 3 or at least two devices each configured like the second device 11 in FIG. 3. In other words, FIG. 3 may be described as follows: The underlying idea of this exemplary embodiment is to convert the speech captured by the microphone 13 at the first device 10 into text and store it. Then, at the second device 11, the audio signal that is to be reproduced at the speakers (which, in principle, should correspond to the speech recorded at the first device 10) is also converted into text, such as a string of text. This string is then sent to the first device 10, where it is compared to the stored text and then displayed on the screen 16. Note that this process involves analyzing the human-understandable message at the application level. This process also identifies past time instants and indicates quality (message intelligibility).

For example, the user of the first device 10 speaks a sentence. These words are captured by the microphone 13 and digitized; these digital audio samples preferably form a raw audio signal. The raw audio signal is encoded, compressed and transmitted to the second device 11. The raw audio signal is also delivered to software module A1, the extraction unit 18. Software module A1 performs speech-to-text conversion. The output of software module A1 is a string with timestamps, preferably a sequence of characters forming words that form sentences. Therefore software module A1 is configured to receive a continuous digital input stream corresponding to the analogue audio signal captured by the microphone. Sometimes some processing is performed on the input audio signal, such as to reduce background noise. Alternatively, the input signal provided at the input of software module A1 may be a processed signal coming from the videoconference system (e.g., a filtered signal). The input signal could also be the compressed signal, or the compressed, encoded and decoded signal (all done at the first device 10), which could be used to evaluate whether there is too much signal compression which compromises the intelligibility of the content. The software module A1 can also be configured to split the continuous input data stream into segments to process each of them simultaneously. This requires a memory to store segments of the incoming signal. Each of the segments is analyzed, possibly using a trained model or based on machine learning techniques, to translate the sequence of raw audio samples into words.

The incoming audio signal can be time-stamped based on a synchronization device such as an internal clock. The term “time-stamped” preferably means that each sample in the raw signal has a value that identifies the moment in time when it was acquired; for instance, the time elapsed since a reference event or a value in UTC format (e.g., Jan. 28, 2022, 17:03:01.23). The reference event can be an absolute time instant (e.g., 1 Jan. 1970 at 00:00:00 UTC) or a relative time instant (e.g., the moment when the device was turned on). The timestamp may not be explicit for all timestamp samples; only a few values or parameters may be stored, and the rest can be calculated or inferred.

Because the novel method involves communicating through the internet, it is assumed that the internal clock is synchronized with an external reference such as the Network Time Protocol, NTP. Such synchronization typically can be performed with low error, in the range of milliseconds (i.e., small enough to be neglected in speech applications). After the speech-to-text conversion, the identified words can be time-stamped as well, indicating e.g., the moment when the pronunciation of the word started and the moment when the pronunciation of the word ended. Likewise the pause between words can be calculated as well. Alternatively, instead of relying on network time, even though it is very accurate, it is often simpler to rely on time periods elapsed from a well-defined starting point in time.

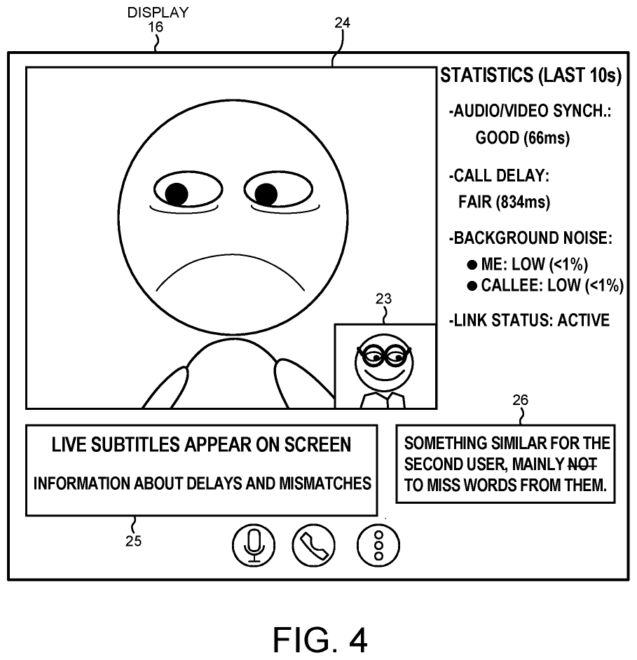

The output of software module A1 (extraction unit 18) is delivered to software module B (comparison unit 22), which first displays the text on the screen 16 of the user of the first device 10, e.g., as shown in FIG. 4. The text displayed on screen 16 corresponds to the analysis or speech-to-text conversion carried out at the first device 10. For instance, the text may appear in white color. Besides the text itself, some information regarding the time length of the words, sentences or pauses may be displayed as well. While this is only an intermediate step, this information may already be valuable to the user of the first device 10.

Software module B causes the text to be displayed on the display 16 as soon as the text is available, in white color to indicate that this corresponds to the data directly captured by the microphone 13. Information about the time length can be displayed as well. This text corresponding to automatic subtitles of the speech of the first user can be used by the first user as an indication of whether the user is speaking clearly, too fast or too slow. For instance, if the speech-to-text system fails to identify the words, it may mean that the first user is not vocalizing clearly enough or that too much background noise is being captured by the microphone 13.

At this moment in time, software module B (comparison unit 22) waits for the information coming from the second device 11. If the first user keeps on talking, multiple text lines may be displayed at the first device 10 in the same way and with the same information as described above. If too many lines appear without feedback from the second device 11, this is already an indication that the communication is not working properly and an indication of an aberrance may be displayed because the information coming back from the second device 11 is preferably automatic (no manual action).

In general, the novel method is fully automated for the user, as no explicit user input is required to send summary messages, such as the fourth and sixth sequences of information between the first and second devices.

In parallel with the process described so far, the digital audio signal that was delivered to software module A1 (extraction unit 18) is also encoded, compressed and transmitted via the internet to the second device 11. The second device 11 receives the data from the internet and reconstructs the message. This whole process from microphone capture at the transmitter through encoder, network transmission, receiver decoder, jitter buffer and finally playback naturally adds a delay. Ultimately an audio signal is reconstructed and, as soon as it is available, is played at the speaker 15 of the second device 11.

At the moment that the digital audio signal has been reconstructed and is ready to be converted back to analogue to be reproduced at the speaker 15, it is also sent to software module A2 (extraction unit 21) of the second device 11. This module performs essentially the same operation as does software module A1 by converting the speech (reconstructed digital audio samples in this case) into text and timestamping it. The output (e.g., a text string with timestamps) is then sent back via the internet to the first device 10 and may be regarded as a summary of the message received by the first device 10. A text string (with timestamps) is much smaller than digital audio or video signals. The amount of information that is sent back from second device 11 to first device 10 is thus almost negligible compared to the amount of information that is sent when transmitting actual audio or video data. Because of the smaller size, this information can be sent via a protocol that guarantees information integrity, such as TCP, so that if a packet is lost, it is retransmitted until its reception is acknowledged at the other side. This eliminates the possibility of the original message being properly delivered but not properly notifying the sender (the message is lost on the way back).

Preferably the timestamps are absolute. If the clock synchronization is not accurate enough, a relative timestamp may be used. In both cases, the time length of each word, sentence and pause can be evaluated with high precision. If absolute timestamps are available, then it is also possible to evaluate the communication delay between the data captured by the microphone at the first device 10 and the audio reproduced at the second device 11. If using RTCP protocol (RTP control protocol), which is normally used for both audio and video communication, this delay can be straight-forwardly monitored.

Software module A2 analyzes the speech of the user of the first device 10. When receiving the message at the first device 10, it is delivered to software module B. The received message is compared to the message that had been stored. This comparison is very simple because both messages include text strings (messages) and numbers (timestamps). The timestamps are compared to determine whether the audio signal was reproduced at the same speed and whether the pauses between words were properly respected. Note that the information loss can also involve losing the pauses, and then the words would be pronounced together one right after the other. With absolute timestamps, the communication delay can also be determined.

Alternatively, when only relative timestamps are available, the total delay can be estimated from the moment when the message was sent until the text corresponding to that message returns. While this leads to an overestimation of the delay (compared to the actual delay, it involves an additional speech-to-text conversion and must travel back), it also defines an upper bound for the delay. If this upper bound is already small enough, then so is the actual delay.

After having received the information and having compared it, the only task that remains to be performed is to display the information in a simple way for the user of the first device 10. For the speech part, the simplest way is to display text, such as subtitles. To acknowledge the reception and highlight the mismatches, a different color can be used. For instance, green may indicate matching text and time lengths; yellow may indicate time lengths differing more than e.g., 5%; red may indicate that either a word was not reproduced at the other side (red with strikethrough) or that an unexpected word arrived (red).

No action is automatically taken based on the differences. The differences are simply reported to the user of the first device 10 as a means for the user to evaluate the necessity of repeating part of the speech, for example.

The information may be displayed in different ways. For instance, regarding the delays and time lengths of the words and pauses, lines or numbers can be used instead of colors. The length of the line may indicate the time length of the word or pause. Two different lines can be used, one for the first device 10 and one for the second device 11, to compare the lengths of both lines and determine whether they are similar.

In one embodiment, the software modules A1-A4 shown in FIG. 3 are all identical to extraction unit 18. In another embodiment, the software modules A2-A3, which extract information from signals that travel across the internet, are slightly modified and denoted as extraction unit 21. The software module B is the comparison unit 22.

FIG. 4 shows an exemplary graphical user interface (GUI) of the novel system for monitoring call quality. For example, the graphical user interface may be on the first device 10 or second device 11.

A video of two users or participants in a video conference is displayed on the graphical user interface. For example, if the GUI is the display 16 of the first device 10, a small video panel 23 shows the user of the first device 10, the first user which could be a physician. If viewed by the first user, the panel 23 shows the “self-video”, i.e., the video captured of the first user during the video conference. The large panel 24 shows the second user, which could be a patient to whom a mental health treatment is being administered.

A panel 25 indicates to the first user the acoustic output that the second user received based on the captured speech signals from the first user. In this example, during the video conference, live subtitles appear in panel 25 while the first user is talking to indicate what the second user has received based on the captured speech signals from the first user. The information contained in the subtitles in panel 25 is an indication of delays, mismatches or omitted words. For example, if the first user said, “You should not do this,” and the second user heard “You should do this” because the word “not” was lost during transmission, a subtitle in panel 25 may appear that reads “You should not do this”.

Similarly, in panel 26, live subtitles appear while the second user is talking to indicate what the first user has received based on the captured speech signals from the second user. Panel 26 thus assists the first user in recognizing whether any words from the second user were missed or omitted.

For example, the second user may reply to the message “You should do this” received by the second user with “I do want to”. In this case, in panel 26 the subtitle “I do want to” appears. This allows the first user to distinguish the situation in which the second user says “I do want to” without any loss in transmission from the situation in which the second user says “I do not want to” with the word “not” being lost in transmission because in the latter case the subtitle in panel 26 would read “I do not want to”.

In addition to that, general call quality statistics, such as the level of background noise, the audio and video synchronization and call delay etc. are indicated to the first user on the GUI. In the example shown in FIG. 4, the general call quality statistics are displayed next to the panel 24.

Relating to audio and video synchronization, it is important to remember that the audio signal and the video signal are independent signals which can get out of synchronization, especially when the communication channel is unreliable and multiple packets of data may be lost at once. In an embodiment that monitors both audio and video signals, an extracted frame number for the video signal can be sent together with the time-stamped text from the second device 11 to the first device 10. The comparison unit 22 (software module B) then analyzes whether the extracted number associated with a certain text matches the number that was added to the same text at the first device 10. Mismatches in this check reveal desynchronization at the second device 11. Automatic corrective actions may be taken (e.g., sending to the second device 11 a message indicating to duplicate a few frames to restore the synchronization) or the aberrance can simply be reported to the user of the first device 10.

The call delay can be precisely evaluated based on the extracted frame number or the text generated by the speech-to-text conversion, in combination with absolute timestamps. Each extracted frame number or text from audio data may be time-stamped in order to define a pair of characteristic events with its corresponding time instant of reproduction at the second device 11. If relating to audio data, the speech-to-text conversion can be used to identify characteristic instants in the speech, like the beginning of a word. The pair of characteristic events are sent via the secure channel to the comparison unit 22, where the counterpart audio segment (or reference audio signal) can be found. Any delay is then evaluated as the difference between timestamps.

When absolute timestamps are not available, an upper bound for the delay can be determined. Instead of comparing, for a certain text element, the timestamp at the first device 10 with a timestamp at the second device 11, the timestamp at the first device 10 is now compared to the time instant when this particular text element was received again by the first device 10 via the secure channel.

In case of a video conference with multiple participants, for each of the participants the GUI as shown in FIG. 4 is displayed. In other words, the video conference with multiple participants is represented as multiple simultaneous video conferences with two participants. Alternatively, multiple panels 26 may be presented in one GUI as shown in FIG. 4, reflecting the messages received from different participants of the video conference.

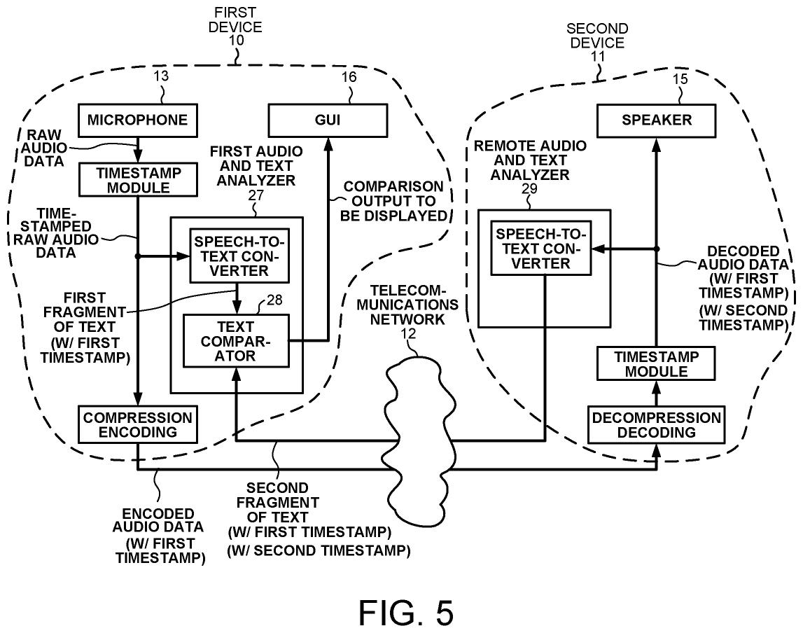

FIGS. 5-7 illustrate yet other embodiments of the novel system in which a first device 10 communicates with a second device 11 via a telecommunications network 12.

FIG. 5 illustrates a system that monitors the quality by which the speech of a user of the first device 10 is conveyed to a user of the second device 11. In one application, the user of the first device 10 is a physician or mental health profession who is remotely providing a mental health treatment to a patient who is the user of the second device 11. The physician can better deliver the mental health therapy if the physician is made aware of instances in which the physician's speech is not being accurately reproduced for the patient, such as due to poor transmission quality over the telecommunications network. Thus, the system of FIG. 5 is used to improve the delivery of telehealth and remote mental health therapies.

FIG. 5 illustrates that raw audio data representing the speech of the physician is acquired by a microphone 13 of a first device 10. The raw audio data is sent to a timestamp module to generate time-stamped raw audio data. The timestamp of the time-stamped raw audio data is just one of many timestamps that indicates, for example, the time instant at which the user began to speak a word. The time-stamped raw audio data is compressed and encoded to generate encoded audio data with a first timestamp.

The encoded audio data with the first timestamp is sent via the telecommunications network 12 to a second device 11. For example, the telecommunications network 12 uses the internet. At the second device 11, the encoded audio data is decompressed and decoded and input into a timestamp module to generate decoded audio data with a first timestamp and a second timestamp. Based on the decoded audio data with the first timestamp and the second timestamp, the second device 11 outputs an audio signal via speaker 15. The audio signal output by speaker 15 is the speech of the mental health professional that is presented to the patient, who is the user of the second device 11. The first timestamp indicates when the raw audio data was acquired (spoken by the physician), and the second timestamp indicates when the encoded audio data is received by the second device 11.

The time-stamped raw audio data is also input into a first audio and text analyzer 27 of the first device 10. The first audio and text analyzer 27 includes a speech-to-text converter and a text comparator 28. In the first audio and text analyzer 27, the time-stamped raw audio data is converted into a first fragment of text with a first timestamp by the speech-to-text converter. Then the first fragment of text with the first time stamp is input into the text comparator.

In the second device 11, the decoded audio data with the first timestamp and the second timestamp is input into a remote audio and text analyzer 29 of the second device 11. The remote audio and text analyzer 29 includes a speech-to-text converter that converts the decoded audio data with the first timestamp and the second timestamp into a second fragment of text with the first timestamp and the second timestamp. The second fragment of text with the first timestamp and the second timestamp is sent to the text comparator 28 of the first audio and text analyzer 27 of the first device 10. The text comparator 28 compares the first fragment of text with the first timestamp to the second fragment of text with the first timestamp and the second timestamp to determine whether the first and second fragments of text are exactly the same or the same to a degree that a human being would not detect any difference. The result of the comparison of the text comparator 28 is then displayed on the GUI of the display 16.

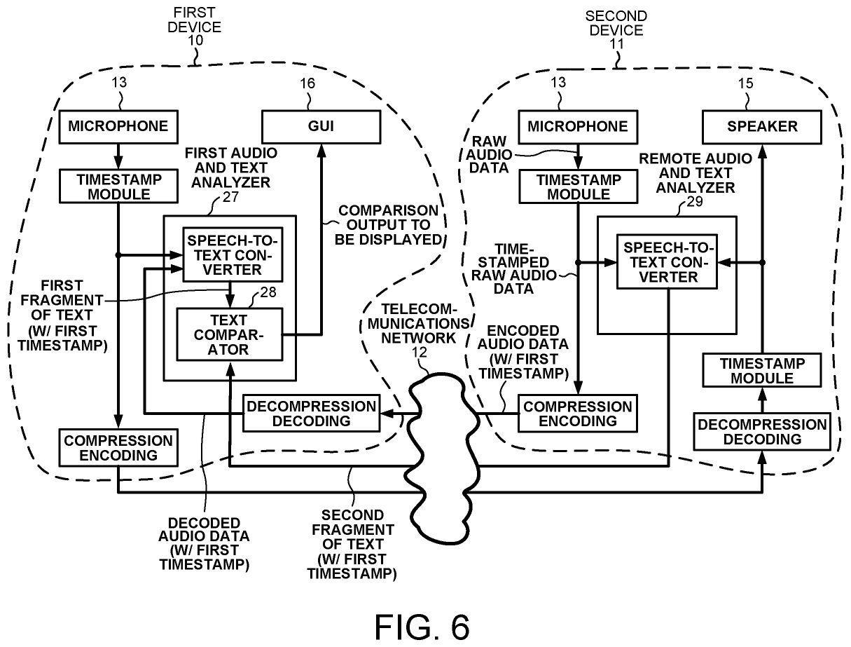

FIG. 6 shows the embodiment of FIG. 5 with some additional features used to indicate to the physician whether the speech of the patient has been accurately conveyed to the physician. In the system of FIG. 6, raw audio data in the form of the patient's speech is captured by the microphone 13 of the second device 11. The raw audio data is sent to a timestamp module to generate time-stamped raw audio data. The time-stamped raw audio data is compressed and encoded to generate encoded audio data with a first timestamp.

The encoded audio data with the first timestamp is transmitted via the telecommunications network 12 to the first device 10, where it is decompressed and decoded to generate decoded audio data with the first timestamp. The speech-to-text converter of the first audio and text analyzer 27 receives the decoded audio data representing the speech of the patient. The speech-to-text converter of the first audio and text analyzer 27 generates a first fragment of text with the first time stamp that is input into the text comparator 28.

At the second device 11, the time-stamped raw audio data representing the speech of the patient is also input into the speech-to-text converter of the remote audio and text analyzer 29, which generates a second fragment of text with the first timestamp. The second fragment of text with the first timestamp is transmitted to the first device 10 via the telecommunications network 12 and is input into the text comparator 28. The text comparator 28 then compares the first fragment of text, which was generated by speech-to-text conversion at the first device 10, to the second fragment of text, which was generated by speech-to-text conversion at the second device 11, the source of the speech by the patient. The result of the comparison of the text comparator 28 is then displayed to the physician on the GUI of the display 16 of the first device 10.

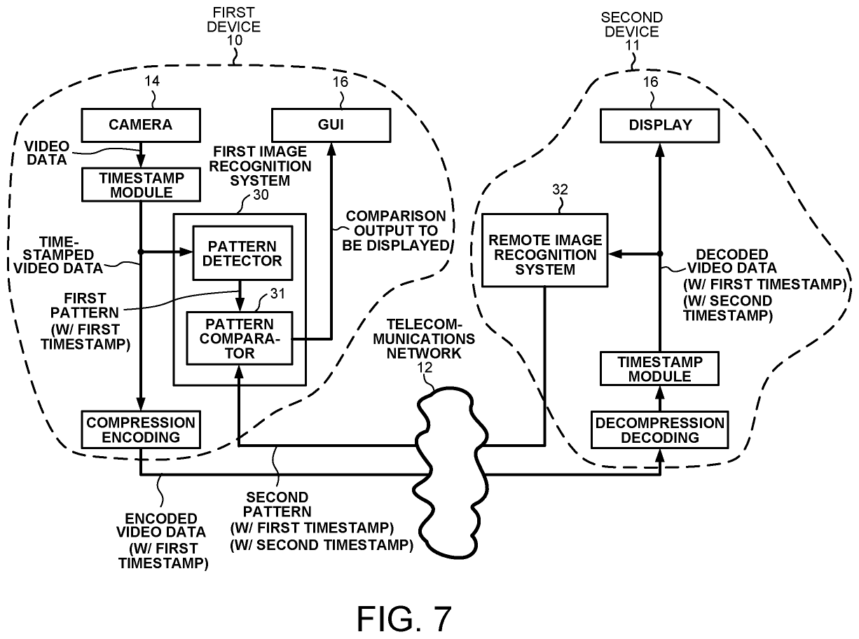

FIG. 7 shows an embodiment of the system for monitoring transmission quality where video data is being transmitted from the first device 10 to the second device 11. Video data is acquired by a video camera 14 of the first device 10. The video data is sent to a timestamp module to generate time-stamped video data. The time-stamped video data is compressed and encoded to generate encoded video data with a first timestamp.

The encoded video data with the first timestamp is transmitted via the telecommunications network 12 to the second device 11, where the video data is decompressed and decoded and input into a timestamp module to generate decoded video data with the first time-stamp and the second time stamp. Based on the decoded video data with the first timestamp and the second time stamp, the second device 11 displays an image and/or video on the display 16.

The time-stamped video data is also received by a first image recognition system 30 of the first device 10. The first image recognition system 30 includes a pattern detector and a pattern comparator 31. The pattern detector detects a pattern with the first timestamp in the time-stamped video data and sends the first pattern with the first timestamp to the pattern comparator 31.

The decoded video data with the first timestamp and the second timestamp is input into a remote image recognition system 32 of the second device 11. The remote image recognition system 32 includes a pattern detector. The pattern detector detects a second pattern with the first timestamp and the second timestamp in the decoded video data and sends the second pattern with the first timestamp and the second timestamp to the pattern comparator 31 in the first device 10. The pattern comparator 31 compares the first fragment of video data, which was generated by pattern recognition at the first device 10, to the second pattern of video data, which was generated by pattern recognition at the second device 11, which received the video data after it was transmitted across the telecommunications network. The result of the comparison of the pattern comparator 31 is then displayed on the GUI of the display 16 of the first device 10. The information shown to the user of the first device 10, such as a physician, indicates whether the video data displayed to the user of the second device 11, such as a patient, is an accurate reproduction of the video data generated by the camera 14 of the first device 10. For example, the comparison might indicate to the physician that some video frames were not transmitted to the patient but rather were missing from the video content displayed to the patient.

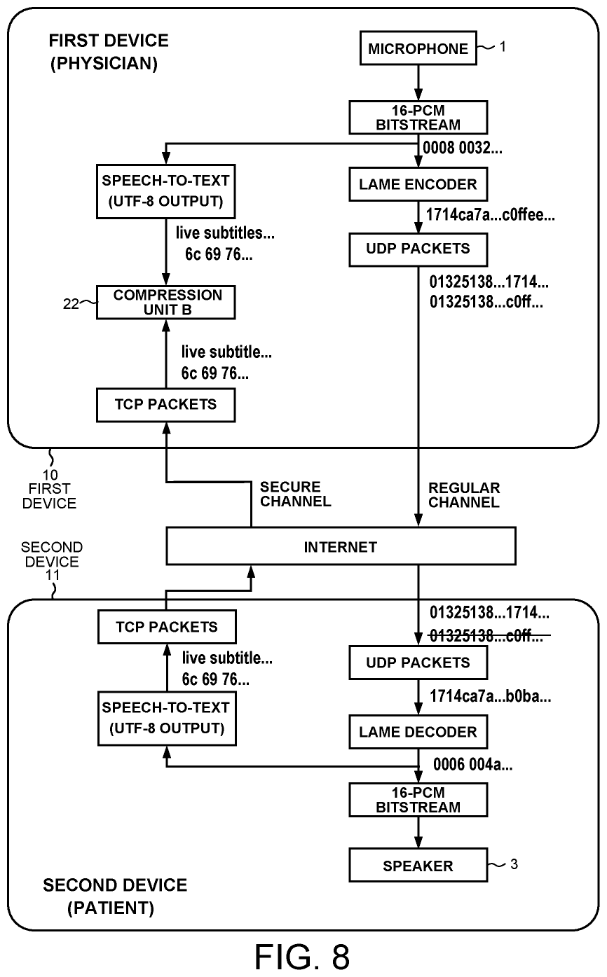

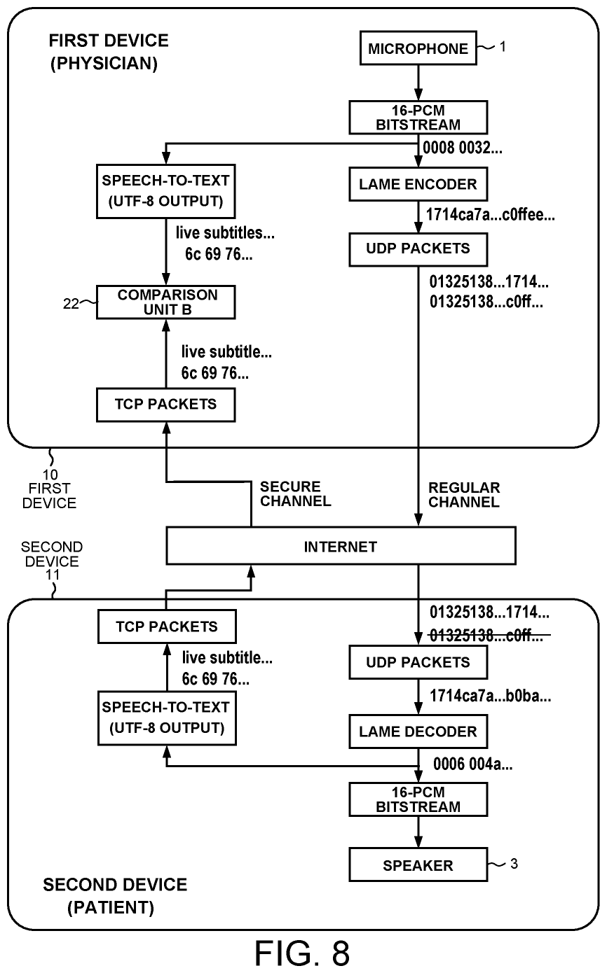

FIG. 8 is a diagram that provides more detail about how audio data is transmitted between the first device 10 and the second device 11 of the novel system. First, speech by the first user is captured by the microphone 13 of the first device 10. The acquired audio data, for example, takes the form of a pulse code modulation (PCM) bitstream showing the value of each 16-bit sample in hexadecimal. Two exemplary samples are displayed: 0008 and 0032.

The PCM bitstream is then converted, for example, by a LAME encoder that converts the input bitstream into another bitstream, for example into MP3-format. The encoded bitstream is split into segments. Two such segments are shown: 1714ca7a and c0ffee.

Each of the segments is sent in a user datagram protocol (UDP) packet to the second device 11. Two such packets are shown: 01325138 . . . 1714ca7a and 01325138 . . . c0ffee. The first numbers indicate the header, which does not contain audio data. After the header comes the body with audio data (the message). When transmitting the packages via the internet, some packets may be lost, as is indicated by the strikethrough in FIG. 8. In this example, the package 01325138 . . . c0ffee is lost during transmission.

The received UDP packets are unpacked by the second device 11, and a bitstream is created. Ideally, the unpacked content should be the same as the packaged content, but due to lost packets and errors, it may differ. The incoming bitstream is decoded by a LAME decoder, and an audio signal is recovered. Due to compression losses, even if no packages would have been lost, the exact original message may not be recovered.

In the first and second devices, the PCM bitstreams are sent to a speech-to-text conversion module, which converts the audio data or samples (e.g., a waveform) into a sequence of characters (in this example, encoded in UTF-8). For example, each group of 2 bytes corresponds to a character (6c->1, 69->i, 76->v, . . . ). The character “20” can be used to designate a split in the characters between words.

In contrast to the audio data that is being transmitted in UDP packets or packages, the output of the speech-to-text conversion module is sent as transmission control protocol packets or packages. Thus, there are two separate communication channels employing different communication protocols. A first channel using a UDP communication protocol and a separate second channel using a TCP communication protocol. The TCP protocol may be regarded as having a higher transmission fidelity and cyber security than the UDP communication protocol.

Simply comparing the words of the text fragments character-by-character or word-by word, or in a more general wording entity-by-entity, can reveal differences:

For example, the output of the speech-to-text conversion module of the first device 10 may be as follows:

6c 69 76 65 20 73 75 62 74 69 74 6c 65 73 20 61 70 70 65 61 72

And the output of the speech-to-text conversion module of the second device 11 may be as follows:

6c 69 76 65 20 73 75 62 74 69 74 6c 65 20 61 70 70 65 61 72

The output of the speech-to-text conversion module in this example is in 8-Bit UCS Transformation Format (UTF-8). The comparison unit 22 of the first device 10 compares these two output sequences. The output of the speech-to-text conversion module of the first device 10 includes an additional 73 between 65 and 20. This implies that the character corresponding to 73 was not received by the user of the second device 11.

Because of the timestamps, it is possible automatically to synchronize the output of the speech-to-text conversion module of the second device 11 with the output of the speech-to-text conversion module of the first device 10, without having to correlate signals.

The amount of data in bytes sent via the TCP channel is significantly lower than the amount of data sent via the UDP channel. For example, a person uttering the phrase “live subtitles appear on screen” leads to 2.8 s of audio signal corresponding to 22400 bytes of data to be packaged and transmitted. In contrast, the corresponding UTF-8 output of a speech-to-text conversion module converting the phrase “live subtitles appear on screen” into text corresponds to only 31 bytes. The amount of data required to transmit the same amount of human intelligible information is thus 1000 times smaller.

At the receiver side, the message “live subtitles appear on screen” may be reproduced as “life subtitles appear on screen”. The difference in sound between the words “live” and “life”, however, is small enough for the content/meaning of the message to be properly received.

Although the present invention has been described in connection with certain specific embodiments for instructional purposes, the present invention is not limited thereto. Accordingly, various modifications, adaptations, and combinations of various features of the described embodiments can be practiced without departing from the scope of the invention as set forth in the claims.

1-19. (canceled)

20. A method comprising:
receiving an audio signal containing encoded audio data onto a first audio and text analyzer, wherein a first portion of the encoded audio data is timestamped with a first time, wherein the audio signal containing the encoded audio data is received onto a remote audio and text analyzer, and wherein the encoded audio data received onto the remote audio and text analyzer includes a second portion of the encoded audio data that is also timestamped with the first time;
converting, by the first audio and text analyzer, the first portion of the encoded audio data into a first fragment of text;
converting, by the remote audio and text analyzer, the second portion of the encoded audio data into a second fragment of text;
receiving, by the first audio and text analyzer, the second fragment of text;
comparing the first fragment of text to the second fragment of text; and
indicating on a graphical user interface whether the first fragment of text exactly matches the second fragment of text.

21. The method of claim 20, wherein the indicating whether the first fragment of text exactly matches the second fragment of text involves displaying in a separate color those portions of the first fragment of text that do not exactly match the second fragment of text.

22. The method of claim 20, wherein the indicating whether the first fragment of text exactly matches the second fragment of text includes indicating that a word of the first fragment of text is missing from the second fragment of text.

23. The method of claim 20, wherein the first portion of the encoded audio data is timestamped with the first time indicating when a first word of the first fragment of text was first pronounced.

24. The method of claim 20, wherein the second portion of the encoded audio data that is received onto the remote audio and text analyzer is received already timestamped with the first time.

25. The method of claim 20, wherein the second portion of the encoded audio data that is received onto the remote audio and text analyzer is timestamped with a second time by the remote audio and text analyzer, and wherein the second time is correlated to the first time by accounting for an estimated transmission time to the remote audio and text analyzer.

26. The method of claim 20, wherein the first time is based on a Network Time Protocol (NTP) of a telecommunications network over which the second fragment of text is received from the remote audio and text analyzer.

27. The method of claim 20, wherein the second fragment of text is received by the first audio and text analyzer from the remote audio and text analyzer over a telecommunications network using transmission control protocol (TCP).

28. A method comprising:
receiving an audio signal containing encoded audio data from a remote audio and text analyzer, wherein a first portion of the encoded audio data is timestamped with a first time;
converting the first portion of the encoded audio data into a first fragment of text;
receiving a second fragment of text from the remote audio and text analyzer, wherein a second portion of the encoded audio data was converted by the remote audio and text analyzer into the second fragment of text, and wherein the second portion of the encoded audio data is also timestamped with the first time;
comparing the first fragment of text to the second fragment of text; and
indicating on a graphical user interface whether the first fragment of text exactly matches the second fragment of text.

29. The method of claim 28, wherein the indicating whether the first fragment of text exactly matches the second fragment of text involves displaying in a separate color those portions of the first fragment of text that do not exactly match the second fragment of text.

30. The method of claim 28, wherein the indicating whether the first fragment of text exactly matches the second fragment of text includes indicating that a word of the first fragment of text is missing from the second fragment of text.

31. The method of claim 28, wherein the second portion of the encoded audio data is timestamped with the first time indicating when a first word of the second fragment of text was first pronounced.

32. The method of claim 28, wherein the first portion of the encoded audio data is received from the remote audio and text analyzer already timestamped with the first time.

33. The method of claim 28, wherein the first portion of the encoded audio data that is received from the remote audio and text analyzer is timestamped with a second time when the first portion is received, and wherein the second time is correlated to the first time by accounting for an estimated transmission time from the remote audio and text analyzer.

34. The method of claim 28, wherein the first time is based on a Network Time Protocol (NTP) of a telecommunications network over which the audio signal is received from the remote audio and text analyzer.

35. The method of claim 28, wherein the audio signal is received from the remote audio and text analyzer over a telecommunications network using transmission control protocol (TCP).

36-40. (canceled)
